(19) United States
(12) Patent Application Publication
(10) Pub. No.: US 2007/0187460 A1
(43) Pub. Date: Aug. 16, 2007

(54) THERMAL INTERFACE MATERIAL AND SEMICONDUCTOR DEVICE INCORPORATING THE SAME

(75) Inventors: CHING-TAI CHENG, Tu-Cheng (TW); NIEN-TIEN CHENG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Taipei Hsien (TW)

(21) Appl. No.: 11/309,786

(22) Filed: Sep. 26, 2006

(30) Foreign Application Priority Data
Feb. 15, 2006 (CN) 200610033725.6

(51) Int. Cl. A47J 36/02

(52) U.S. Cl. 228/101

(57) ABSTRACT

A semiconductor device (10) includes a heat source (12), a heat-dissipating component (13) for dissipating heat generated by the heat source, and a thermal interface material (14) filled in spaces formed between the heat source and the heat-dissipating component. The thermal interface material includes 30% to 60% by weight of bismuth, up to 40% by weight of tin, and the rest indium.

### FIELD OF THE INVENTION

The present invention relates to a thermal interface material which is interposable between a heat source and a heat-dissipating component. The present invention also relates to a semiconductor device using the thermal interface material.

### DESCRIPTION OF RELATED ART

With the fast development of the electronics industry, advanced electronic components such as CPUs (central processing units) are being made with ever faster operating speeds. During operation of the advanced electronic components, a large amount of heat is generated. In order to ensure good performance and reliability of the electronic components, their operational temperature must be kept within a suitable range. Generally, a heat dissipating apparatus such as a heat sink or a heat spreader is attached to a surface of the electronic component, so that the heat is transferred from the electronic component to ambient air via the heat dissipating apparatus. However, the contact surfaces between the heat dissipating apparatus and the electronic component are rough and therefore are separated from each other by a layer of interstitial air, no mater how precisely the heat dissipating apparatus and the electronic component are brought into contact. Thus, the contact resistance of heat conductivity between the two surfaces is relatively high. A grease of silicone composition is always applied to the contact surfaces to eliminate the air interstices between the heat dissipating apparatus and the electronic component in order to improve heat dissipation.

The grease of silicone composition includes silicone oil and metal-oxide fillers filled in the silicone oil. The silicone oil is used for filling the air interstices to create an intimate contact between the heat dissipating apparatus and the electronic component, whilst the metal-oxide fillers are used for improving the thermal conductivity of the grease to thereby increase the heat dissipation efficiency of the heat dissipating apparatus. However, a weak thermal conductivity of the silicone oil limits the thermal conductivity of the grease of silicone composition. Therefore, a thermal interface material having better thermal conductivity than the grease of silicone composition is needed.

### SUMMARY OF THE INVENTION

The present invention relates, in one respect, to a thermal interface material for electronic products, and in another respect, to a semiconductor device using the thermal interface material. According to a preferred embodiment of the present invention, the semiconductor device includes a heat source, a heat-dissipating component for dissipating heat generated by the heat source, and a thermal interface material filled in spaces formed between the heat source and the heat-dissipating component. The thermal interface material includes 30% to 60% by weight of bismuth, up to 40% by weight of tin, and the rest indium.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present thermal interface material can be better understood with reference to the following drawings. The components in the drawings are not necessarily drawn to scale, the emphasis instead being placed upon clearly illustrating the principles of the present thermal interface material. Moreover, in the drawings, like reference numerals designate corresponding parts throughout the several views.

FIG. 1 is a schematic cross-sectional view of a semiconductor device having a thermal interface material according to a preferred embodiment of the present invention.

### DETAILED DESCRIPTION OF THE INVENTION

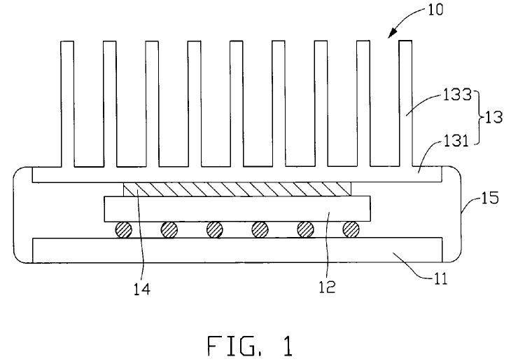

Referring to FIG. 1, a semiconductor device 10 according to a preferred embodiment of the present invention is shown. The semiconductor device 10 includes a heat source 12 disposed on a circuit board 11, a heat-dissipating component 13 for dissipating heat generated by the heat source 12, and a layer of thermal interface material 14 sandwiched between the heat source 12 and the heat-dissipating component 13. The heat source 12 is an electronic component, such as a central processing unit (CPU) of a computer, which needs to be cooled. The heat-dissipating component 13 is a heat sink, which includes a base 131 and a plurality of fins 133 disposed on the base 131. The heat-dissipating component 13 is securely attached to the circuit board 11 via a resilient fixing member 15, which provides a resilient force for clamping the heat-dissipation component 13 and the circuit board 11 together. The base 131 of the heat-dissipating component 13 is sandwiched between the fixing member 15 and the circuit board 11, and is urged downwardly towards the heat source 12 on the circuit board 111 via the resilient force exerted thereon by the resilient fixing member 15. The thermal interface material is heated to melt so as to fill in spaces formed between the heat source 12 and the base 131 of the heat-dissipating component 13 when the heat source 12 operates at a temperature of 60° C.˜80° C. The layer of the thermal interface material 14 has a smaller area than that of the heat source 12, and a thickness thereof is from 20 μm˜100 μm which prevents the molten thermal interface material 14 from leaking from the spaces between the heat source 12 and the base 131 of the heat-dissipating component 13.

The thermal interface material is indium-bismuth alloy which makes the thermal interface material have a better thermal conductivity than the grease of silicone composition. The heat transfer capability between the heat source 12 and the heat-dissipating component 13 is therefore increased. The thermal interface material has a lower melting point from 60° C.˜80° C. and includes 30% to 60% by weight of bismuth and the rest indium. Indium and bismuth of the weight ratios are melted and mixed together to obtain the thermal interface material.

Indium is a metallic material having a low hardness from 3 Hv to 14 Hv. The indium-bismuth alloy accordingly has a low hardness, which makes the thermal interface material hardly scratch the heat source when it is disposed thereon. The weight ratio of indium in the thermal interface material enables it to melt at the temperature from 60° C. to 80° C.; therefore, the thermal interface material can be melted to fill in the spaces formed between the heat source 12 and the heat-dissipating component 13 when the heat source 12 works. Indium also has good ductility, which enables the thermal interface material to be easily expanded and spread in the spaces when pressed so that the heat source 12 can have an intimate contact with the heat-dissipating component 13.

Bismuth makes up 30% to 60% by weight of the thermal interface material. The weight ratio of bismuth is used to keep the melting point of the indium-bismuth alloy (the thermal interface material) at the range from 60° C. to 80° C., which is lower than that of indium, i.e., 156.4° C.

The thermal interface material may further include 0 to 40% by weight of tin, which causes the thermal interface material to be indium-bismuth-tin alloy having similar melting point and ductility to the indium-bismuth alloy. The weight ratio of tin is also used to keep the melting point of the thermal interface material at the range from 60° C. to 80° C. Tin has a lower cost than that of indium and bismuth, so that the cost of the indium-bismuth-tin alloy (thermal interface material) is lowered, in comparison with the indium-bismuth alloy. Tin preferably makes up 16.5%˜36% by weight of the thermal interface material.

Table 1 shows four embodiments of the present thermal interface material. In the four embodiments, indium, bismuth and tin have different weight ratios with each other, which results in the corresponding thermal interface material having different melting points.

TABLE 1

| Thermal interface | Melting point | | | |
|---|---|---|---|---|
| material | (° C.) | Indium (%) | Bismuth (%) | Tin (%) |
| 1 | 60 | 51 | 32.5 | 16.5 |
| 2 | 79~80 | 26 | 57 | 17 |
| 3 | 60~80 | 12 | 52 | 36 |
| 4 | 70 | 66.3 | 33.7 | 0 |

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of portions within the principles of the invention to the full extent indicated by the broad general meaning of the terms in which the appended claims are expressed.

What is claimed is:

1. A thermal interface material for being applied between a heat-generating electronic component and a heat-dissipating component, comprising:
30% to 60% by weight of bismuth;
up to 40% by weight of tin; and
the rest indium.

2. The thermal interface material as described in claim 1 comprising 33.7% by weight of bismuth and the rest indium.

3. The thermal interface material as described in claim 1 comprising 16.5%˜36% by weight of tin.

4. The thermal interface material as described in claim 3 comprising 32.5% by weight of bismuth, 16.5% by weight of tin, and the rest indium.

5. The thermal interface material as described in claim 3 comprising 52% by weight of bismuth, 36% by weight of tin, and the rest indium.

6. The thermal interface material as described in claim 3 comprising 57% by weight of bismuth, 17% by weight of tin, and the rest indium.

7. A semiconductor device comprising:
a heat source;
a heat-dissipating component for dissipating heat generated by the heat source; and
a layer of thermal interface material filled in spaces formed between the heat source and the heat-dissipating component, the thermal interface material comprising:
30% to 60% by weight of bismuth;
up to 40% by weight of tin; and
the rest indium.

8. The semiconductor device as described in claim 7, wherein the melting point of the thermal interface material is at a temperature from 60° C. to 80° C.

9. The semiconductor device as described in claim 7, wherein a thickness of the layer of the thermal interface material is from 20 μm to 100 μm.

10. The semiconductor device as described in claim 9, wherein the layer of the thermal interface material has a smaller area than that of the heat source.

11. The semiconductor device as described in claim 7, wherein the thermal interface material comprises 33.7% by weight of bismuth and the rest indium.

12. The semiconductor device as described in claim 7, wherein the thermal interface material comprises 16.5%˜36% by weight of tin.

13. The semiconductor device as described in claim 12, wherein the thermal interface material comprises 32.5% by weight of bismuth, 16.5% by weight of tin, and the rest indium.

14. The semiconductor device as described in claim 12, wherein the thermal interface material comprises 52% by weight of bismuth, 36% by weight of tin, and the rest indium.

15. The semiconductor device as described in claim 12, wherein the thermal interface material comprises 57% by weight of bismuth, 17% by weight of tin, and the rest indium.
